(19) United States
(12) Patent Application Publication
(10) Pub. No.: US 2014/0247997 A1
(43) Pub. Date: Sep. 4, 2014

(54) INFORMATION PROCESSING SYSTEM, INFORMATION PROCESSING METHOD, AND COMPUTER PROGRAM PRODUCT

(71) Applicant: KABUSHIKI KAISHA TOSHIBA, Tokyo (JP)

(72) Inventors: Masashi NISHIYAMA, Kawasaki-shi (JP); Masahiro SEKINE, Tokyo (JP); Hidetaka OHIRA, Kawasaki-shi (JP); Kaoru SUGITA, Iruma-shi (JP); Yusuke TAZOE, Tokyo (JP); Goh ITOH, Tokyo (JP)

(73) Assignee: KABUSHIKI KAISHA TOSHIBA, Tokyo (JP)

(21) Appl. No.: 14/193,248

(22) Filed: Feb. 28, 2014

(30) Foreign Application Priority Data
Mar. 1, 2013 (JP) 2013-041062

(51) Int. Cl. G06K 9/62

(52) U.S. Cl. CPC G06K 9/6202
USPC 382/218

(57) ABSTRACT

According to an embodiment, an information processing system includes a determination unit, a selection unit, and a display control unit. The determination unit is configured to determine whether a first feature value extracted from a first image and a second feature value extracted from a second image are identical or similar. The selection unit is configured to select content data from a plurality of content data so that the selected content data is different between when it is determined that the first feature value and the second feature value are identical or similar and when it is determined that the first feature value and the second feature value are not identical or similar. The display control unit is configured to display the selected content data on a display unit.

### CROSS-REFERENCE TO RELATED APPLICATION

This application is based upon and claims the benefit of priority from Japanese Patent Application No. 2013-041062, filed on Mar. 1, 2013; the entire contents of which are incorporated herein by reference.

### FIELD

Embodiments described herein relate generally to an information processing system, an information processing method, and a computer program product.

### BACKGROUND

Technologies to share spatial information among a plurality of devices and to display virtual information suitable for a position and a posture of each device are known.

In conventional technologies, it is possible to share information on the position and the posture of a device relative to another device in space in front of oneself. However, it is not possible to share, among devices, information on what object exists in front of oneself. For this reason, it is not possible to, for example, perform a process of controlling virtual information to be displayed depending on the object.

### BRIEF DESCRIPTION OF THE DRAWINGS

FIG. 1 is a block diagram of an information processing system according to the present embodiment;

FIG. 2 is a diagram illustrating an example of a data structure of history information;

FIG. 3 is a flowchart of a content selection process according to the present embodiment;

FIG. 4 is a diagram illustrating an example of a situation to which the present embodiment is applied;

FIG. 5 is a diagram illustrating an example of a situation to which the present embodiment is applied;

FIG. 6 is a diagram illustrating an example of a situation to which the present embodiment is applied;

FIG. 7 is a block diagram of an information processing system according to a first variation;

FIG. 8 is a block diagram of an information processing system according to a second variation;

FIG. 9 is a diagram illustrating a flow of an entire content selection process; and

FIG. 10 is a hardware configuration diagram of a device according to the present embodiment.

### DETAILED DESCRIPTION

According to an embodiment, an information processing system includes a determination unit, a selection unit, and a display control unit. The determination unit is configured to determine whether a first feature value extracted from a first image and a second feature value extracted from a second image are identical or similar. The selection unit is configured to select content data from a plurality of content data so that the selected content data is different between when it is determined that the first feature value and the second feature value are identical or similar and when it is determined that the first feature value and the second feature value are not identical or similar. The display control unit is configured to display the selected content data on a display unit.

Preferred embodiments of an information processing system according to the present invention will be described in detail below with reference to the accompanying drawings.

As described above, it is not possible to perform a process of controlling content data (such as virtual information) to be displayed depending on an object by a conventional method. For example, it is not possible to change content data depending on whether an object is observed (such as image capturing by an image capturing unit) with one device, or the object is observed with a plurality of devices. Likewise, it is not possible to change content data depending on the number of times a same object has been observed.

The information processing system according to the present embodiment selects and outputs different content data from a plurality of content data depending on whether an object observed by one or more information processing devices (terminals) is identical or similar. The information processing system selects different content data depending on a situation including how many terminals are observing the object simultaneously, whether the terminals (or users of the terminals) belong to an identical group, and when the object has been observed. This enables, for example, a plurality of terminals (users) to share the object and time. For example, when a plurality of users pick up an image of a same object simultaneously, it is possible to realize a function of displaying a coupon (an example of content data) different from that in a case where the image of the object is captured by one user. When a plurality of users pick up an image of a same object simultaneously, it is possible to realize a function of displaying a reply (an example of content data) to a problem regarding the object. Thus, it is possible to select appropriate content data depending on a situation of a device that observes an object.

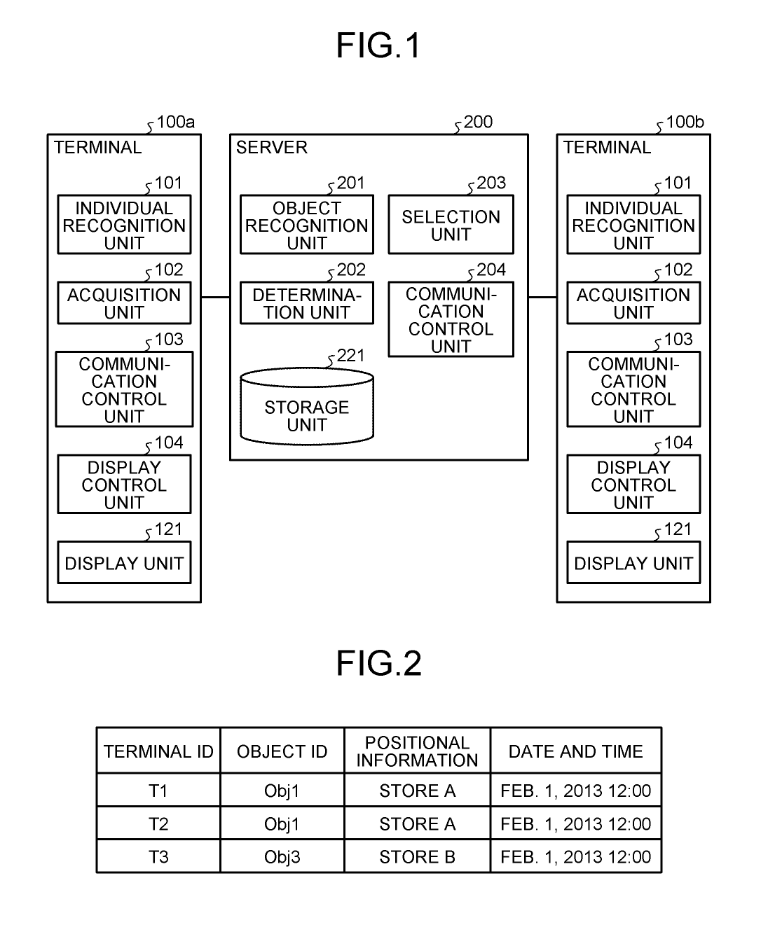

FIG. 1 is a block diagram illustrating an example of a configuration of the information processing system according to the present embodiment. As illustrated in FIG. 1, the information processing system includes terminals 100a and 100b that function as information processing devices, and a server 200 that functions as a server device.

The terminals 100a and 100b, which have similar functions, are merely referred to as a terminal 100 if it is not necessary to distinguish the terminals 100a and 100b. The number of the terminal 100 is not limited to two, but may be any number that is one or more. The terminal 100 and the server 200 are, for example, connected over any network, such as the Internet and a local area network (LAN).

The terminal 100 includes an individual recognition unit 101, an acquisition unit 102, a communication control unit 103, a display control unit 104, and a display unit 121.

The display unit 121 is a display device, such as a liquid crystal display, for displaying various information.

The individual recognition unit 101 recognizes a user of the terminal 100. The individual recognition unit 101 recognizes the user by, for example, an authentication process using authentication information (such as a user ID and a password) inputted by an operation unit (such as a touch panel, a keyboard, and a mouse) that is not illustrated. A user recognition method is not limited to this method. Any method conventionally used may be applied. For example, a method of referring to user information stored in the terminal 100 in advance may be used. Authentication processes including face authentication and authentication using biometric information may be applied.

The acquisition unit 102 acquires an object image. The acquisition unit 102 may include, for example, a digital camera and a digital camcorder.

The communication control unit 103 controls communication with an external device, such as the server 200 and another terminal 100. The communication control unit 103 transmits, for example, an image acquired by the acquisition unit 102 to the server 200. The communication control unit 103 receives content data transmitted from the server 200.

The display control unit 104 controls display of information on the display unit 121. The display control unit 104 displays, for example, content data received from the server 200 on the display unit 121.

The individual recognition unit 101, the acquisition unit 102, the communication control unit 103, and the display control unit 104 may be implemented by, for example, execution of a program by a processing device, such as a central processing unit (CPU), that is, by software. The individual recognition unit 101, the acquisition unit 102, the communication control unit 103, and the display control unit 104 may be implemented by hardware, such as an integrated circuit (IC), or by hardware and software together.

Next, an example of a configuration of the server 200 will be described. The server 200 includes an object recognition unit 201, a determination unit 202, a selection unit 203, a communication control unit 204, and a storage unit 221.

The storage unit 221 stores various information. The storage unit 221 stores, for example, a recognition database to be referred to in a recognition process by the object recognition unit 201. The storage unit 221 also stores a content database including a plurality of content data to be transmitted to the terminal 100 and the like. The storage unit 221 also stores history information regarding an object recognized in the past.

The recognition database is a database for storing data to be referred to when the object recognition unit 201 recognizes an object from an image. The recognition database stores, for example, data that associates object identification information (an object ID) with a feature value.

The content database is a database that associates, for example, identification information on the recognized object (the object ID) with one or more content data to be transmitted to the terminal 100 that has acquired the image of the object. The feature value extracted from the image may be associated with the content data and stored, instead of the object ID.

The content database may associate, with the object ID (or the feature value), content data to be displayed in a case where an identical or similar feature value is extracted from a plurality of images, and content data to be displayed otherwise, and store these data. This enables the selection unit 203 to select different content data from a plurality of content data in the content database depending on whether or not the feature value is identical or similar.

The history information is information on the object recognized by the object recognition unit 201. FIG. 2 is a diagram illustrating an example of a data structure of the history information. As illustrated in FIG. 2, the history information includes a terminal ID, an object ID, positional information, and a date and time.

The terminal ID is identification information for identifying the terminal 100. The positional information represents, for example, a position where the image of the recognized object has been acquired. FIG. 2 illustrates an example of representation of the positional information by a name. Any method of representation, however, may be used as long as the method can identify the position. For example, if the terminal 100 includes a GPS function, the position may be represented by latitude and longitude, or the like.

The history information is referred to when the determination unit 202 determines whether a plurality of objects recognized from a plurality of respective images are identical. The data structure of the history information in FIG. 2 is one example. The data structure of the history information is not limited to this example. For example, the user ID may be stored instead of the terminal ID. The user ID is, for example, a user ID of a user recognized by the individual recognition unit 101. Alternatively, the feature value may be stored instead of the object ID. In this case, the determination unit 202 may determine whether the feature values extracted from the plurality of respective images are identical or similar with reference to the history information.

The storage unit 221 may include any storage medium commonly used, such as a hard disk drive (HDD), an optical disk, a memory card, and a random access memory (RAM).

The object recognition unit 201 recognizes the object captured in the image from the image transmitted from the terminal 100. The object recognition unit 201 extracts from the image, for example, the feature value representing the feature of the image. The object recognition unit 201 then recognizes the object by comparing the extracted feature value with the feature value in the recognition database. The object recognition unit 201 recognizes the object by, for example, searching the recognition database for the object ID corresponding to the feature value having a high degree of similarity with the feature value extracted from the image.

A method of recognizing an object is not limited to this method. Any method conventionally used may be applied as long as the method can recognize an object from an image. Any feature value, such as a histogram of oriented gradients (HOG) feature value, a scale invariant feature transform (SIFT) feature value, and a combination thereof may be used as a feature value.

The determination unit 202 determines whether the feature values extracted from the plurality of respective images are identical or similar. The determination unit 202 determines, for example, whether a first feature value extracted from a first image by the object recognition unit 201 and a second feature value extracted from a second image by the object recognition unit 201 are identical or similar.

In the present embodiment, the object is recognized by the object recognition unit 201. The determination unit 202 may therefore determine whether the feature values extracted from the plurality of respective images are identical or similar by determining whether or not the plurality of objects recognized from the plurality of respective images are identical.

The selection unit 203 selects different content data depending on whether or not the feature values extracted from the plurality of respective images are identical or similar. The selection unit 203 selects, for example, appropriate content data from a plurality of content data stored in the content database in the storage unit 221. The different content data may be created in advance and stored in the content database. A plurality of different content data may be created from the content data of the content database.

The communication control unit 204 controls communication with an external device, such as the terminal 100. The communication control unit 204 receives, for example, the image captured (acquired) by the terminal 100 from the terminal 100. The communication control unit 204 transmits the content data selected by the selection unit 203 to the terminal 100.

The object recognition unit 201, the determination unit 202, the selection unit 203, and the communication control unit 204 may be implemented by, for example, execution of a program by a processing device, such as a central processing unit (CPU), that is, by software. The object recognition unit 201, the determination unit 202, the selection unit 203, and the communication control unit 204 may be implemented by hardware, such as an integrated circuit (IC), or by hardware and software together.

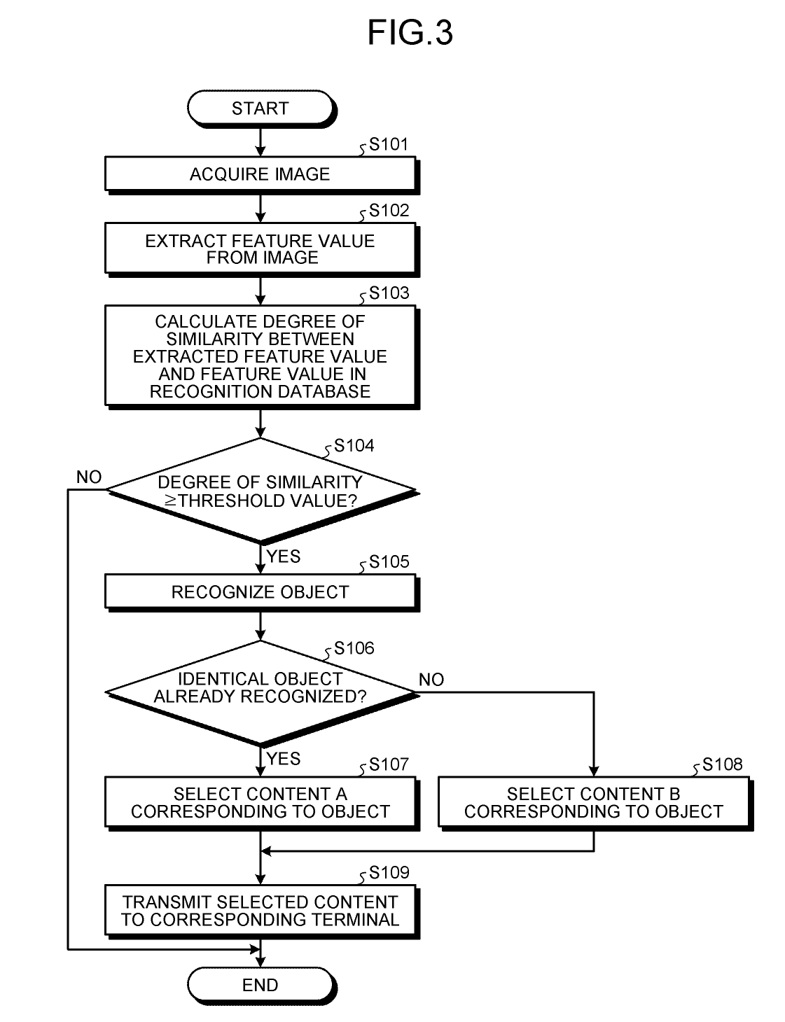

Next, a content selection process performed by the terminal 100 according to the thus-configured present embodiment will be described with reference to FIG. 3. FIG. 3 is a flowchart illustrating an example of the content selection process according to the present embodiment.

First, the acquisition unit 102 of the terminal 100 acquires an image (step S101). The acquired image is, for example, transmitted to the server 200 by the communication control unit 103. The communication control unit 103 may transmit, together with the image, information including a user ID of a user recognized by the individual recognition unit 101, a terminal ID of the terminal 100, and positional information representing a position of the terminal ID to the server 200.

The object recognition unit 201 of the server 200 extracts a feature value from the received image (step S102). The object recognition unit 201 calculates a degree of similarity between the extracted feature value and a feature value stored in the recognition database (step S103). The object recognition unit 201 determines whether or not the calculated degree of similarity is equal to or higher than a predetermined threshold value (step S104). If the degree of similarity is lower than the threshold value (step S104: No), the content selection process ends.

If the degree of similarity is equal to or higher than the threshold value (step S104: Yes), the object recognition unit 201 recognizes that the object is an object corresponding to the feature value with the degree of similarity being higher than the threshold value (step S105). For example, if the recognition database remembers data that has associated an object ID with a feature value, the object recognition unit 201 recognizes the object by identifying the object ID corresponding to the feature value with the degree of similarity being equal to or higher than the threshold value.

Next, the determination unit 202 determines whether or not the object identical to the recognized object has already been recognized (step S106). For example, the determination unit 202 determines whether the object ID identical to the identified object ID has been stored in the history information in the storage unit 221. If the identical object ID has been stored, the determination unit 202 determines that the object identical to the recognized object has already been recognized.

If the object identical to the recognized object has already been recognized (step S106: Yes), the selection unit 203 selects content data (referred to as content A) to be outputted in a case where the identical object has been recognized as content data corresponding to the object (step S107). If the object identical to the recognized object has not been recognized (step S106: No), the selection unit 203 selects content data (referred to as content B) to be outputted in a case where the identical object has not been recognized as content data corresponding to the object (step S108).

The communication control unit 204 transmits the selected content data to the corresponding terminal 100 (step S109). For example, if an object recognized from an image acquired by the terminal 100a is identical to an object recognized from an image acquired by the terminal 100b, the communication control unit 204 transmits the selected content A to each of the terminal 100a and the terminal 100b. If an object identical to the object recognized from the image acquired by the terminal 100a has not been recognized, the communication control unit 204 transmits the selected content B only to the terminal 100a.

Next, a specific example of the information processing system to which the present embodiment is applied will be described. The present embodiment is applicable to, for example, the information processing system in which a coupon (an example of content data) that can be used to purchase a product (an object) is displayed on the terminal 100 when an image of the product is captured by the terminal 100.

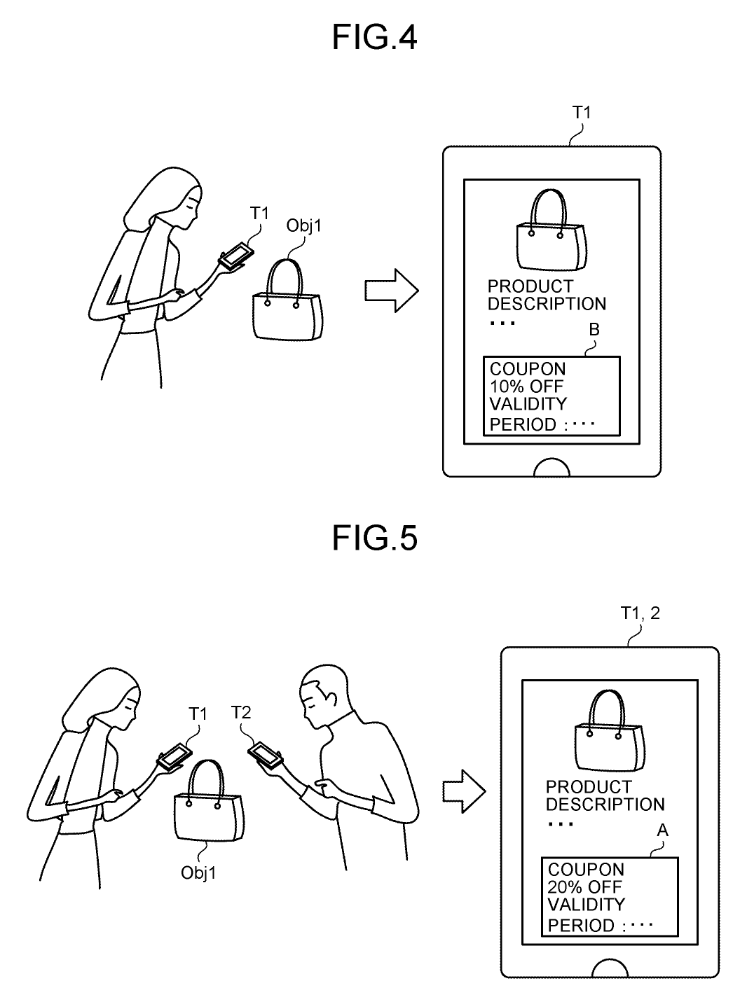

FIG. 4 and FIG. 5 are diagrams illustrating an example of a situation to which the present embodiment is applied. FIG. 4 illustrates an example of content data (content B) to be displayed when an image of a product (hereinafter also referred to as product Obj1) whose object ID is “Obj1” is captured only by the terminal 100 (hereinafter also referred to as terminal T1) whose terminal ID is “T1”. In this case, because the flowchart in FIG. 3 determines that an identical object has not been recognized (step S106: No), the content B is displayed only on the terminal T1. In the example in FIG. 4, the content B including a coupon that is “10% OFF” is displayed.

FIG. 5 illustrates an example of content data (content A) to be displayed when an image of the product Obj1 is captured by the terminal 100 (hereinafter also referred to as terminal T2) whose terminal ID is “T2”, together with the terminal T1. In this case, because the flowchart in FIG. 3 determines that an identical object has already been recognized (step S106: Yes), the content A is displayed both on the terminal T1 and the terminal T2. In the example in FIG. 5, the content A including a coupon that is “20% OFF” is displayed.

Thus, even if an image of an identical object (product) is captured, a different coupon may be issued depending on a situation of a device for observing the object (such as whether or not a plurality of users pick up an image of an identical object simultaneously). This enables a store to attract more customers.

Up until now, the determination unit 202 has determined only whether or not an identical object has already been recognized to switch content data. The determination unit 202 may, however, be configured to make a determination by adding another condition. For example, the terminal 100 or the user of the terminal 100 may be classified into a group in advance, and further content data may be selected depending on whether or not the group is identical. This enables realization of a function such as outputting a coupon having a higher discount rate for a group when, for example, the user picks up an image of a product together with an acquaintance.

Different content data may be selected depending on whether or not a date and time on which an image of an object has been acquired satisfies a predetermined condition of a date and time. For example, the determination unit 202 may determine not only whether a same object has been recognized by a plurality of terminals 100, but also whether the same object has been recognized by the plurality of terminals 100 almost simultaneously (a difference of the date and time is within a threshold value). If recognized almost simultaneously, content data different from that selected otherwise may be selected. If a same object has been repeatedly recognized by the identical terminal 100 on different days, content data different from that selected otherwise may be selected. This enables realization of a function such as increasing a discount rate if, for example, an identical user continues to pick up an image of a same product every day. In addition, as a condition of the date and time, any condition may be applied, such as time in one day.

Different content data may be selected depending on whether or not a position (a place) where an image of an object has been acquired satisfies a predetermined condition of a place. The information processing system may be configured to select and output a coupon having a higher discount rate if, for example, after an image of a product (such as a product in a catalog) is captured at a user's home, an image of the identical product (a real product) is captured at a store that is located in another place. As a condition of the place, any condition may be applied, such as an identical place, a different place, and a place associated in advance.

Different content data may be selected depending on the number of the terminal 100, a type of the terminal 100, and an operation of the terminal 100 that has recognized a same object. For example, a coupon having a higher discount rate may be selected in proportion to the number of the terminal 100 that has recognized the same object. If the terminal 100 includes, for example, a sensor that can detect an operation of the terminal 100 (such as an acceleration sensor, a gyroscopic sensor, and a gravity sensor), information sensed by this sensor may be used to determine the operation of the terminal 100 and select different content data depending on the determined operation.

Different content data may be selected depending on a sequence in which images of objects are acquired. The system may be configured to select a different coupon in a case where a type of a product and an image capturing sequence differ from each other, such as, for example, in a case where images are captured in a sequence of product A and product B, in a case where images are captured in a sequence of product B and product A, and in a case where images are captured in a sequence of product A and product C.

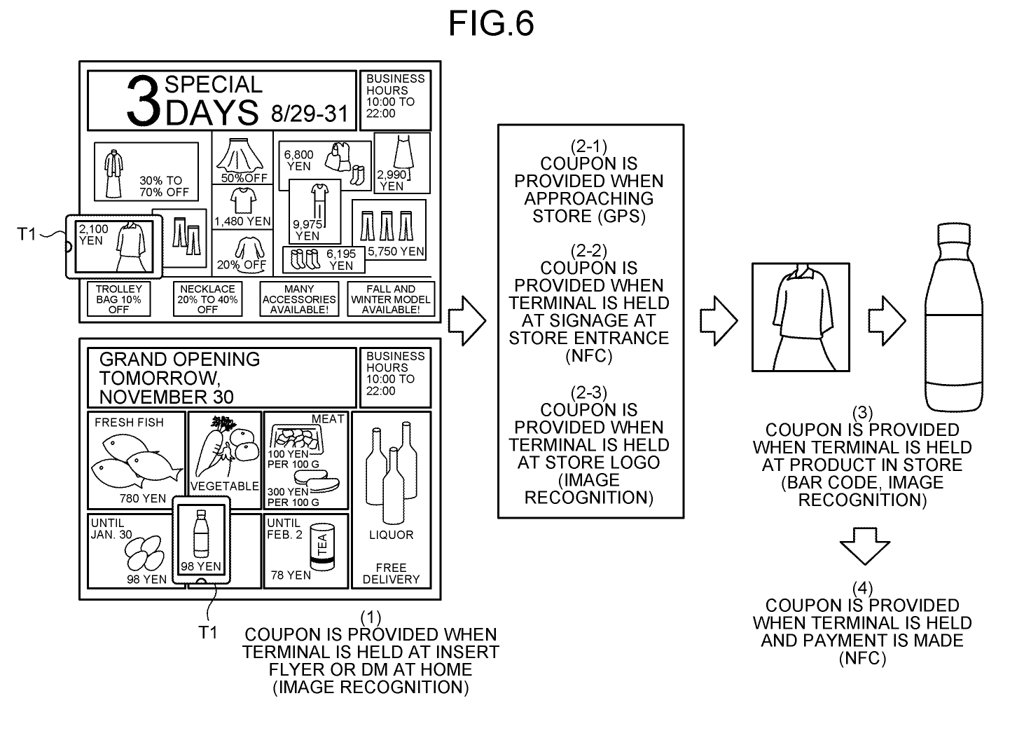

FIG. 6 is a diagram illustrating another example of a situation to which the present embodiment is applied. FIG. 6 illustrates an example of various situations in which a coupon is issued to the terminal T1.

(1) A user holds the terminal T1, for example, at an insert flyer or a direct mail (DM) at home and picks up an image. The captured image is transmitted to the server 200. The object recognition unit 201 of the server 200 recognizes a product from the received image by an image recognition process. In the example in FIG. 6, clothes printed in an upper flyer and a seasoning printed in a lower flyer are recognized. The selection unit 203 of the server 200 selects a coupon corresponding to each product and transmits the coupon to the terminal T1.

(2) Assume that the user moves to a store in order to purchase the product.

(2-1) If the movement of the user into proximity of the store is sensed by positional information obtained by the GPS function of the terminal T1, another coupon is transmitted.

(2-2) Another coupon may be acquired from digital signage installed at a place including an entrance of the store by near field communications (NFC), etc. In this case, the terminal T1 needs to include a corresponding near field communications function.

(2-3) Another coupon may be acquired when an image of a logo included in a signboard of the real store, etc. is captured.

(3) Another coupon may be acquired when the user enters the store, holds the terminal T1 at the real product, and picks up an image. In this case, the product may be identified by an image recognition process in the same manner as the flyer, etc. The product may be identified by a recognition process of code information such as a bar code attached to the product. According to the present embodiment, as illustrated in FIG. 6, when an image of a product identical to the product whose image has been captured at home is also captured at the store, a coupon having a higher discount rate may be acquired.

(4) Another coupon may be acquired if the terminal T1 includes a payment function using near field communications, etc. and when the user purchases the product with this function.

First Variation

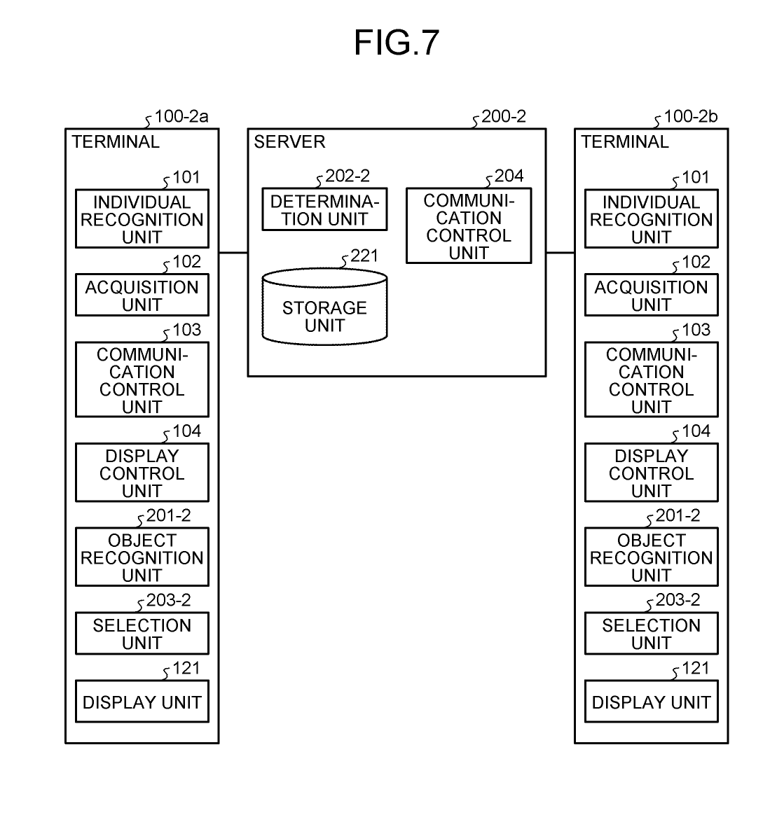

In the above embodiment, an acquired image is transmitted from a terminal 100 to a server 200, and an object is recognized from the image in the server 200. By such a method, a large amount of image data may increase a load on a network. The terminal 100 may therefore be configured to perform object recognition. FIG. 7 is a block diagram illustrating an example of a configuration of an information processing system according to the thus-configured first variation.

Terminals 100-2a and 100-2b according to the first variation (hereinafter also referred to as a terminal 100-2) include an object recognition unit 201-2 and a selection unit 203-2 in addition to units similar to those in the above embodiment (the individual recognition unit 101, the acquisition unit 102, the communication control unit 103, the display control unit 104, and the display unit 121). A server 200-2 includes a determination unit 202-2, a communication control unit 204, and a storage unit 221. The first variation thus differs from the above embodiment in that a recognition process (the object recognition unit 201-2) of an object from an image and a content selection process (the selection unit 203-2) are performed in the terminal 100-2.

In the first variation, for example, the object recognition unit 201-2 accesses a recognition database in the storage unit 221 of the server 200-2 and recognizes an object similar to a feature value extracted from the image. The object recognition unit 201-2 transmits a recognition result to the server 200-2 via the communication control unit 103. For example, the communication control unit 103 transmits the recognition result including a terminal ID, an object ID, and positional information of the terminal 100-2 to the server 200-2. The server 200-2 can thereby store history information illustrated in FIG. 2.

With reference to the history information, the determination unit 202-2 determines whether a feature value extracted from a plurality of images is identical or similar. The determination unit 202-2 transmits a determination result to the terminal 100-2 that has acquired each image.

Depending on the determination result, the selection unit 203-2 selects content data corresponding to the object from a content database stored in the storage unit 221 of the server 200-2.

The first variation thus transmits information representing a recognition result of the object from the image instead of the acquired image itself. This enables reduction of a load on a network.

Second Variation

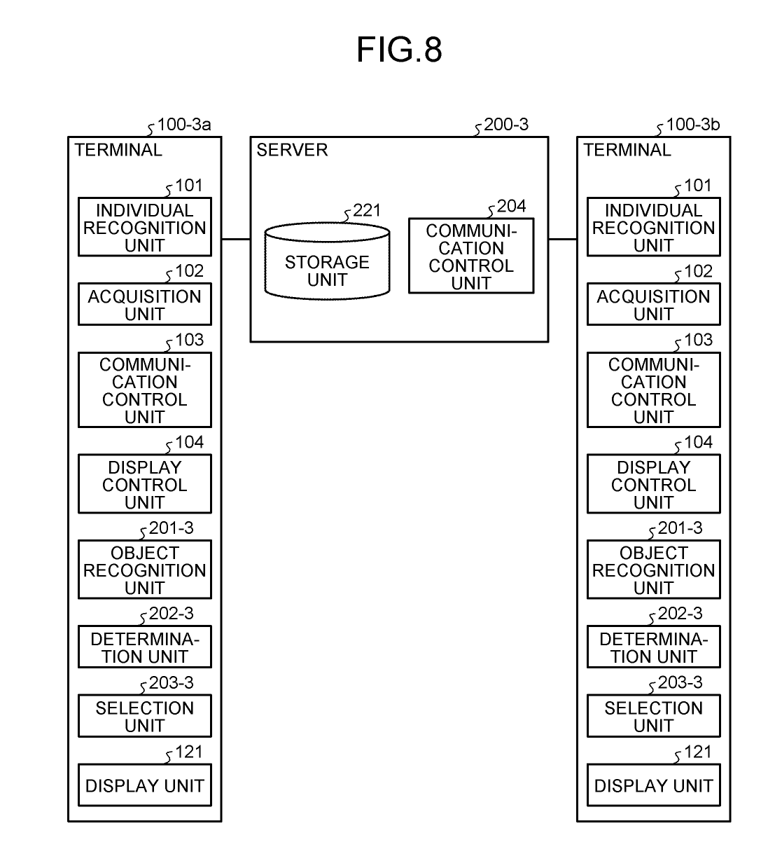

FIG. 8 is a block diagram illustrating an example of a configuration of an information processing system according to a second variation.

Terminals 100-3a and 100-3b according to the second variation (hereinafter also referred to as a terminal 100-3) include an object recognition unit 201-3, a determination unit 202-3, and a selection unit 203-3 in addition to units similar to those in the above embodiment (the individual recognition unit 101, the acquisition unit 102, the communication control unit 103, the display control unit 104, and the display unit 121). A server 200-3 includes a communication control unit 204 and a storage unit 221. The second variation thus differs from the first variation in that a function of the determination unit 202-3 is also performed by the terminal 100-3.

With reference to history information stored in the storage unit 221 of the server 200-3, the determination unit 202-3 may determine whether a feature value extracted from a plurality of images is identical or similar. The determination unit 202-3 may be configured to exchange a recognition result (such as an object ID and a feature value) with the determination unit 202-3 of another terminal 100-3 and to determine whether an identical object has been recognized. In a latter case, it is not necessary to store the history information in the storage unit 221. The terminal 100-3 with which the recognition result is to be exchanged may be, for example, the terminal 100-3 within a range in which the communication control unit 103 is capable of communication.

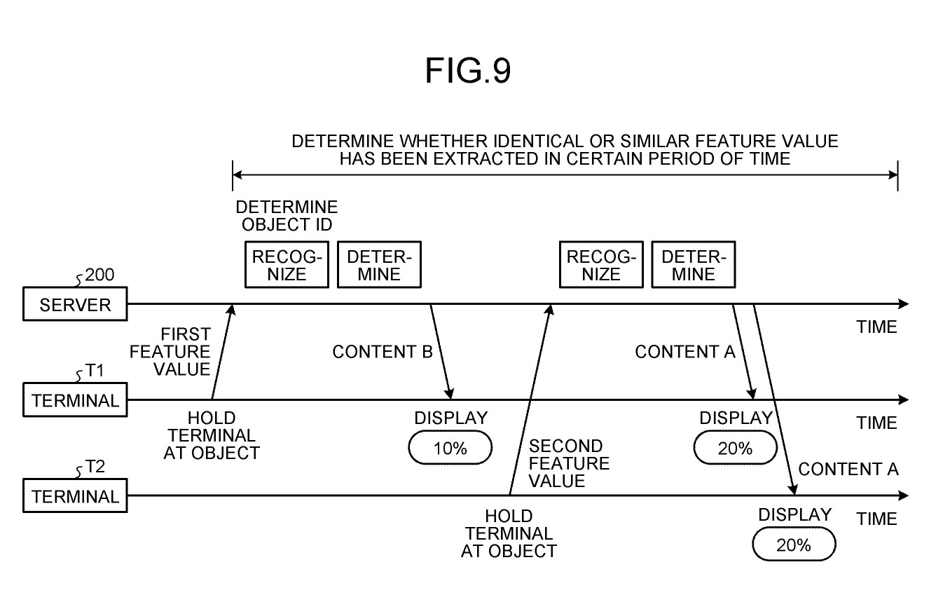

FIG. 9 is a diagram illustrating a flow of an entire content selection process. FIG. 9 illustrates an example in which terminals T1 and T2 extract a feature value from an image, and the server 200 performs recognition and determination of an object using the feature value. A rightward arrow in FIG. 9 represents passage of time.

As illustrated in FIG. 9, assume that an image of a product is first captured by the terminal T1, and a first feature value is obtained from the captured image. The first feature value is transmitted to the server 200. The server 200 determines a corresponding object ID from the first feature value. In addition, the server 200 determines whether an identical or similar feature value has been extracted in a certain period of time. If not extracted, the server 200 transmits, to the terminal T1, content B (for example, a coupon indicating “10% OFF”) to be outputted if an identical or similar feature value is not extracted. The terminal T1 displays the content B.

Assume that an image of the product is subsequently captured by the terminal T2 in a certain period of time, and that a second feature value is obtained from the captured image. The second feature value is transmitted to the server 200. The server 200 determines a corresponding object ID from the second feature value. Assume that the object ID determined from the first feature value coincides with the object ID determined from the second feature value. In this case, the server 200 transmits, to the terminal T1 and the terminal T2, content A (for example, a coupon indicating “20% OFF”) to be outputted if an identical feature value is extracted. Each of the terminal T1 and the terminal T2 displays the content A.

As described above, according to the present embodiments, it is possible to select appropriate content data depending on a situation of a device for observing an object.

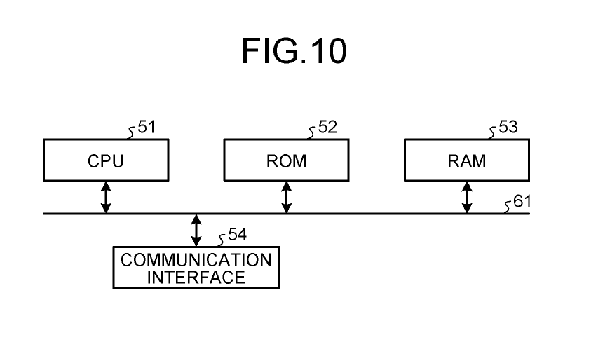

Next, a hardware configuration of a device (a terminal and a server) according to the present embodiments will be described with reference to FIG. 10. FIG. 10 is a diagram illustrating a hardware configuration of the device according to the present embodiments.

The device according to the present embodiments includes a control device, such as a central processing unit (CPU) 51, a storage device, such as a read only memory (ROM) 52 and a random access memory (RAM) 53, a communication interface 54 for communication by connecting to a network, and a bus 61 for connecting each unit.

A program to be executed by the device according to the present embodiments is incorporated in advance in the ROM 52 or the like and provided.

The program to be executed by the device according to the present embodiments may be configured to be an installable file or an executable file. The program may be configured to be recorded in a computer-readable recording medium, such as a compact disk read only memory (CD-ROM), a flexible disk (FD), a compact disk recordable (CD-R), and a digital versatile disk (DVD). The program may be configured to be provided as a computer program product.

Furthermore, the program to be executed by the device according to the present embodiments may be configured to be stored in a computer connected to a network, such as the Internet, and to be provided by allowing download via the network. The program to be executed by the device according to the present embodiments may be configured to be provided or distributed via a network, such as the Internet.

The program to be executed by the device according to the present embodiments may cause a computer to function as each unit of the above-described device (the individual recognition unit, the acquisition unit, the communication control unit, the display control unit, the object recognition unit, the determination unit, and the selection unit). In this computer, the CPU 51 may read the program from the computer-readable storage medium into a main memory device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system, comprising:
a determination unit configured to determine whether a first feature value extracted from a first image and a second feature value extracted from a second image are identical or similar;
a selection unit configured to select content data from a plurality of content data so that the selected content data is different between when it is determined that the first feature value and the second feature value are identical or similar and when it is determined that the first feature value and the second feature value are not identical or similar; and
a display control unit configured to display the selected content data on a display unit.

2. The system according to claim 1, comprising one or more information processing devices and a server device, wherein
the server device includes the determination unit and the selection unit, and
the information processing devices include the display control units.

3. The system according to claim 1, comprising one or more information processing devices and a server device, wherein
the server device includes the determination unit, and
the information processing devices include the selection units and the display control units.

4. The system according to claim 1, comprising one or more information processing devices and a server device, wherein
the server device includes a storage unit that stores the plurality of content data, and
the information processing devices include the determination units, the selection units, and the display control units.

5. The system according to claim 1, further comprising an object recognition unit configured to recognize an object captured in an image based on a feature value extracted from the image, wherein
the determination unit is configured to determine whether a first object recognized based on the first feature value and a second object recognized based on the second feature value are identical.

6. The system according to claim 1, wherein
the determination unit is configured to further determine whether a first group to which a first device that has acquired the first image or a first user who is a user of the first device belongs, and a second group to which a second device that has acquired the second image or a second user who is a user of the second device belongs are identical, and
the selection unit is configured to further select content data difficult between when it is determined that the first group and the second group are identical and when it is determined that the first group and the second group are not identical.

7. The system according to claim 1, wherein
the determination unit is configured to further determine whether a first positional information representing a position where the first image has been acquired and a second positional information representing a position where the second image has been acquired satisfy a predetermined condition, and
the selection unit is configured to further select content data different between when it is determined that the first positional information and the second positional information satisfy the condition, and where it is determined that the first positional information and the second positional information do not satisfy the condition.

8. The system according to claim 1, wherein
the determination unit is configured to further determine whether a first time when the first image is acquired and a second time when the second image is acquired satisfy a predetermined condition, and
the selection unit is configured to further select content data different between when it is determined that the first time and the second time satisfy the condition and when it is determined that the first time and the second time do not satisfy the condition.

9. The system according to claim 1, wherein
the determination unit is configured to further calculate the number of an image determined to be identical or similar each other, and
the selection unit is configured to further select different content data depending on the number.

10. The system according to claim 1, wherein
the determination unit is configured to further determine a type of a first device that has acquired the first image and a type of a second device that has acquired the second image, and
the selection unit is configured to further select different content data depending on the determined type.

11. The system according to claim 1, wherein
the determination unit is configured to further determine an operation of a first device that has acquired the first image and an operation of a second device that has acquired the second image, and
the selection unit is configured to further select different content data depending on the determined operation.

12. An information processing method, comprising:
determining whether a first feature value extracted from a first image and a second feature value extracted from a second image are identical or similar;
selecting content data from a plurality of content data so that the selected content data is different between when it is determined that the first feature value and the second feature value are identical or similar and when it is determined that the first feature value and the second feature value are not identical or similar; and
controlling display of the selected content data on a display unit.

13. A computer program product comprising a computer-readable medium containing a program executed by a computer, the program causing the computer to execute:
determining whether a first feature value extracted from a first image and a second feature value extracted from a second image are identical or similar;
selecting content data from a plurality of content data so that the selected content data is different between when it is determined that the first feature value and the second feature value are identical or similar and when it is determined that the first feature value and the second feature value are not identical or similar; and
controlling display of the selected content data on a display unit.
